(19) United States
(12) Patent Application Publication
(10) Pub. No.: US 2012/0231278 A1
(43) Pub. Date: Sep. 13, 2012

(54) POLYCARBONATE COMPOSITION HAVING IMPROVED FLAME RESISTANCE FOR EXTRUSION APPLICATIONS

(75) Inventors: Ulrich Blaschke, Krefeld (DE); Alexander Meyer, Dusseldorf (DE); Claus Rüdiger, Krefeld (DE); Berit Krauter, Opladen (DE)

(73) Assignee: Bayer Intellectual Property GmbH, Monheim (DE)

(21) Appl. No.: 13/508,250

(22) PCT Filed: Nov. 3, 2010
(86) PCT No.: PCT/EP2010/066735

§ 371 Date: May 4, 2012

(30) Foreign Application Priority Data
Nov. 5, 2009 (DE) 102009052041.4

(51) Int. Cl. C08L 69/00; C08K 5/521; C08K 5/136; B32B 27/06

(52) U.S. Cl. 428/412; 524/127

(57) ABSTRACT

The present invention relates to compositions which contain flame-retardant polycarbonate and are suitable for the production of flame-resistant and milky-white sheets.

The present invention relates to compositions containing polycarbonate and from 0.10 wt. % to 4.00 wt. % of an acrylate-based scattering additive, from 0.50 wt. % to 7.00 wt. % of a bromine-containing flame retardant and from 0.50 wt. % to 7.00 wt. % of a phosphorus-based flame retardant for extrusion applications.

Plastics moulding compositions which have been provided with flameproof properties are used in a large number of applications. Typical fields of use of such plastics materials are electrical engineering and electronics, where they are used inter alia in the production of carriers for live components or in the form of television and monitor casings. However, plastics materials provided with flame-resistant properties have also become firmly established in the field of interior trims for railway vehicles or aircraft. As well as having good flame-retarding properties, the plastics materials used here must also exhibit further positive properties to a high degree. These include inter alia mechanical properties, such as, for example, high impact strength as well as adequate long-term stability towards thermal stress or towards possible damage by the action of light. Such a combination of properties is not always easy to achieve. Although the desired flame resistance can generally be established in plastics materials with the aid of flame retardants, relatively large amounts are often required, which quickly leads to a drastic deterioration of other properties such as, for example, mechanical properties.

Light-scattering properties of the plastics material can be established by the addition of so-called scattering additives. However, the addition of organic scattering additives, in particular those based on acrylate, drastically impairs the fire properties of the composition, and large amounts of a flame retardant must be added in order to establish the desired flame resistance.

It has now been found that the flame resistance of polycarbonate compositions containing scattering additives, that is to say of milky-white or translucent polycarbonate compositions, can be synergistically enhanced by the combined addition of brominated and phosphate-containing flame-retarding additives.

US-A 2003/0069338 discloses in this connection flame-retardant moulding compositions which contain synergistic combinations of cyanoacrylates and flame retardants. The moulding compositions so finished are distinguished by improved flame resistance and improved weathering stability. However, cyanoacrylates can adversely affect the processing behaviour of polycarbonate—for example at high temperatures. The present application does not provide mixtures with cyanoacrylates.

U.S. Pat. No. 6,649,677 discloses that the flame resistance of polycarbonate can be improved by markedly reducing the viscosity of the polycarbonate and adding very specific amounts of phosphorus flame retardants. However, the reduction in viscosity leads to a deterioration of the mechanical properties and is therefore not always a suitable method for establishing flame-retardant properties. Moreover, the flame retardants of the general formula (4) used in the invention disclosed herein and the combination with bromine-containing flame retardants are not described in U.S. Pat. No. 6,649,677.

US-A 2004/0097619 discloses polymer substrates which contain various stabilisers and various flame retardants, including also phosphorus- or halogen-containing flame retardants. However, this application does not relate to extrusion materials which contain acrylate particles. A teaching for action can accordingly not be derived from US-A 20040097619 for the present problem.

JP-A 06041416 describes polycarbonates containing flame retardants based on bromine Combinations of flame retardants are not described. However, high bromine contents are undesirable in the processing of thermoplastics because they tend to give off corrosive and harmful bromine vapours on processing.

The sheets according to the invention are preferably of multilayer construction. Accordingly, they are preferably provided with a UV protective layer which is preferably applied by the coextrusion process. Such extrusion materials are described in the literature.

US-A 2006/0234061 describes multilayer systems comprising a UV protective layer, which contains polyalkylene(meth)acrylate and compounds of the 2,4-bis-(4-phenylphenyl)-6-(2-hydroxyphenyl)-1,3,5-triazine type, as well as a second layer containing polycarbonate. However, an improvement in the flame-retardant properties cannot be achieved with these systems.

In U.S. Pat. No. 6,255,483 and in GB 2317174 A, biphenyl-substituted triazine compounds are described. Mixtures with further additives are mentioned in general form. A specific teaching for the provision of compositions having improved flame-proofing properties is not to be found in the document, however.

It is an object of the present invention to provide compositions containing polycarbonate which exhibit improved flame-retardant properties in combination with a high scattering action. The compositions are to be suitable for milky-white extruded products.

Within the context of the present invention it has now been found, surprisingly, that the flame resistance of extruded polycarbonate articles containing acrylate-based scattering additive can be increased by adding a combination of brominated and phosphate-containing flame retardants. At the same time, good polymer properties such as dimensional stability under heat (which can be determined, for example, by the Vicat temperature) and a low bromine content can be maintained.

The present invention accordingly relates to compositions containing linear and/or branched aromatic polycarbonate and
a) from 0.10 wt. % to 4.00 wt. %, preferably from 0.50 wt. % to 2.00 wt. %, particularly preferably from 0.50 wt. % to 1.5 wt. %, and in a particular embodiment preferably from 1.60 wt. % to 4.00 wt. %, of at least one acrylate-based scattering additive,
b) from 0.50 wt. % to 7.00 wt. %, preferably from 1.00 wt. % to 6.00 wt. %, particularly preferably from 2.00 wt. % to 5.00 wt. %, of at least one bromine-containing flame retardant, preferably based on aromatic oligocarbonates,
c) from 0.50 wt. % to 7.00 wt. %, preferably from 1.00 wt. % to 6.00 wt. %, particularly preferably from 2.50 wt. % to 5.50 wt. %, of at least one phosphorus-based flame retardant, preferably at least one of these phosphorus-based flame retardants is an oligomeric phosphoric acid ester derived from bisphenol A.

The wt. % data are based in each case on the corresponding total composition.

The two flame retardants b) and c) can be used in equal proportions, or the amount of bromine-containing flame retardants b) is greater than the amount of phosphate-containing flame retardants c) or the amount of bromine-containing flame retardants b) is smaller than the amount of phosphate-containing flame retardants c). The use of a larger amount of phosphate-containing flame retardants c) than bromine-containing flame retardants b) is preferred. All amount data are thereby based on percent by weight.

Such compositions can advantageously be used in various applications. The compositions according to the invention are suitable especially for use in the form of sheets for architectural or industrial glazing, such as, for example, wall and roof linings, dome lights or shatterproof glazing, as trims for railway vehicle and aircraft interiors, on each of which high demands are made in terms of flame resistance. Such sheets can be produced in particular by extrusion. The sheets can be solid sheets, preferably having a thickness of from 1 to 10 mm, or twin-wall sheets, such as, for example, multiwall sheets or hollow sections of particular geometry.

In the present application, the extruded sheet is also referred to as the “base layer” and the composition used for its production is referred to as the “base material”. The base layer can optionally also be provided with further (protective) layers and, in particular, with a cover layer on one side or on both sides. Such layers are preferably produced by coextrusion (“coex layer”).

Mouldings of bisphenol A polycarbonate are normally difficult to ignite and can often achieve V2 classification according to Underwriters Laboratories Subject 94 even without special flame-inhibiting additives. With flame-inhibiting additives, halogen additives or antidripping agents, it is in some cases even possible to achieve VO classification according to UL Subject 94.

However, further tests are required in particular for extruded articles for use in the construction sector.

Standard DIN 4102, which is mandatory for the Federal Republic of Germany, classifies building materials in the following classes according to their fire behaviour: building material class A non-combustible, building material class B1 difficult to ignite, building material class B2 normal combustibility, building material class B3 easy to ignite. Flammable building materials are classified in class B1 if they pass the fire shaft test according to DIN 4102.

Thin solid sheets up to 4 mm thick for interior applications or thin multiwall sheets and sections up to a thickness of 10 to 16 mm made of bisphenol A polycarbonate can achieve a B1 in the fire shaft test. For thick solid sheets having a thickness greater than 4 mm or thicker multiwall sheets and sections having thicknesses greater than 16 mm, it is frequently possible to achieve only a B2 for outdoor applications, in particular if the multiwall sheets have complex profiles and/or a high weight per unit area and, in addition, are also coloured with organic additives.

Using the compositions described herein it is possible to produce extruded articles which surprisingly fulfill the above-mentioned requirements for a B1 classification even if they have a complex profile and/or high weights per unit area.

In particular, it is possible using the composition according to the invention to produce sheets having weights per unit area of greater than or equal to 2.4 kg/m², greater than or equal to 2.5 kg/m² and/or greater than or equal to 2.7 kg/m². Further preferred weights per unit area of the sheets are greater than or equal to 2.8 kg/m², greater than or equal to 3.1 kg/m² and/or greater than or equal to 3.4 kg/m². In other embodiments, preferred sheets are those having a weight per unit area of greater than or equal to 3.5 kg/m² and/or greater than or equal to 3.7 kg/m² and sheets having a weight per unit area of greater than or equal to 4.2 kg/m². Particular preference is given also to sheets having the above-mentioned weights per unit area if they are multiwall sheets. Multiwall sheets are also particularly preferred within the context of the present invention regardless of their weight per unit area.

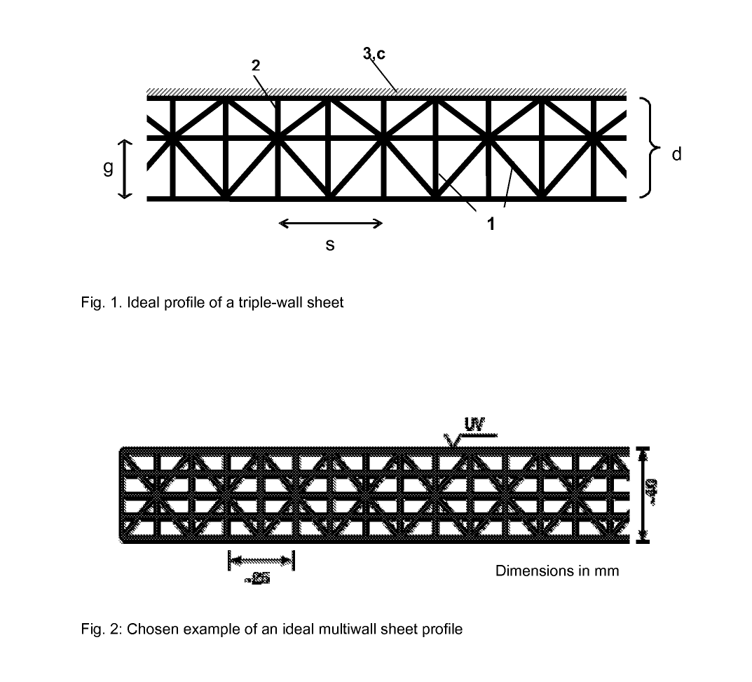

An example of a multiwall sheet (triple-wall sheet having an X-shaped profile) additionally containing a coextruded layer (3) is shown in FIG. 1. The multiwall sheet consists of ribs (1) and chords (2), the uppermost and lowermost chords forming the outer layers. If the ribs are not all parallel to one another perpendicularly to the chords but intersect at an inner chord, the profile is referred to as an X-shaped profile. The spacing between two parallel ribs at the outer chords is s, the spacing of the chord (2) is denoted g. The total thickness of the sheet from outer chord to outer chord is denoted d, the thickness of the coextruded layer (3) is denoted c.

Sheets having the following sheet geometries, for example, are produced from the composition according to the invention:
triple-wall sheet having a thickness of from 12 to 20 mm and a rib spacing of from 12 to 20 mm,
six-wall sheet having a thickness of from 12 to 22 mm and a rib spacing of from 12 to 22 mm,
triple-wall sheet having an X-shaped profile and a thickness of from 12 to 20 mm, wherein the X-shaped structure (formed by 3 ribs) has a width of from 20 to 30 mm,
five-wall sheet having an X-shaped profile and a thickness of from 20 to 50 mm, wherein the X-shaped structure (formed by 3 ribs) has a width of from 20 to 30 mm,
five-wall sheet having an M-shaped profile and a thickness of from 20 to 50 mm, wherein the ribs have a spacing of from 15 to 25 mm.

A further embodiment is shown in FIG. 2, which shows an ideal five-wall sheet having an X-shaped profile.

The present invention relates also to processes for the production of a composition according to the invention, characterised in that polycarbonate and
a) from 0.10 wt. % to 4.00 wt. %, preferably from 0.50 wt. % to 2.00 wt. %, particularly preferably from 0.50 wt. % to 1.5 wt. %, and in a particular embodiment preferably from 1.60 wt. % to 4.00 wt. %, of at least one acrylate-based scattering additive,
b) from 0.50 wt. % to 7.00 wt. %, preferably from 1.00 wt. % to 6.00 wt. %, particularly preferably from 2.00 wt. % to 5.00 wt. %, of at least one bromine-containing flame retardant, preferably based on aromatic oligocarbonates,
c) from 0.50 wt. % to 7.00 wt. %, preferably from 1.00 wt. % to 6.00 wt. %, particularly preferably from 2.50 wt. % to 5.50 wt. %, of at least one phosphorus-based flame retardant, preferably at least one of these phosphorus-based flame retardants is an oligomeric phosphoric acid ester derived from bisphenol A
   are combined and mixed, optionally in a solvent, wherein optionally homogenisation is carried out and the solvent is removed. Individual additives can optionally be premixed with a polycarbonate in powder or granule form and then added. The wt. % data are based in each case on the corresponding total composition.

Polycarbonates for the compositions according to the invention are homopolycarbonates, copolycarbonates, thermoplastic polyester carbonates and blends or mixtures of these polymers. Particular preference is given to aromatic linear and/or branched aromatic polycarbonate, with mixtures of branched and linear polycarbonate being most particularly preferred.

Preference is given to the use of mixtures which contain at least 50.00 wt. %, preferably at least 60.00 wt. %, particularly preferably at least 70.00 wt. %, linear polycarbonate and at least 10.00 wt. % branched polycarbonate. The wt. % data are based in each case on the corresponding total composition.

The linear or branched polycarbonates and copolycarbonates according to the invention generally have mean molecular weights (weight average) of from 2000 to 200,000, preferably from 3000 to 150,000, in particular from 5000 to 100,000, most particularly preferably from 8000 to 80,000, in particular from 12,000 to 70,000 g/mol (determined by means of gel permeation chromatography with polycarbonate calibration).

For the present invention, polycarbonates having a weight-average molecular weight M̅_{w} of from 16,000 to 40,000 g/mol are particularly preferred.

For the preparation of polycarbonates for the compositions according to the invention, reference may be made, for example, to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718 and finally to Dres. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299. The preparation is preferably carried out by the interfacial process or the melt transesterification process and is first described with reference to the interfacial process by way of example.

Compounds preferably to be used as starting compounds are bisphenols of the general formula HO—Z—OH, wherein Z is a divalent organic radical having from 6 to 30 carbon atoms and containing one or more aromatic groups. Examples of such compounds are bisphenols belonging to the group of the dihydroxydiphenyls, bis(hydroxyphenyl)alkanes, indane bisphenols, bis(hydroxyphenyl) ethers, bis(hydroxyphenyl)sulfones, bis(hydroxyphenyl)ketones and α,α′-bis(hydroxy-phenyl)diisopropylbenzenes.

Particularly preferred bisphenols belonging to the above-mentioned groups of compounds are bisphenol A, tetraalkyl bisphenol A, 4,4-(meta-phenylenediisopropyl)diphenol (bisphenol M), 4,4-(para-phenylenediisopropyl)diphenol, N-phenyl-isatin bisphenol, 1,1 -bis-(4-hydroxyphenyl)-3,3,5-trimethylcyclohexane (BP-TMC), bisphenols of the 2-hydrocarbyl-3,3-bis(4-hydroxyaryl)-phthalimidine type, in particular 2-phenyl-3,3-bis(4-hydroxyphenyl)phthalimidine, and optionally mixtures thereof. Particular preference is given to homopolycarbonates based on bisphenol A and to copolycarbonates based on the monomers bisphenol A and 1,1-bis-(4-hydroxyphenyl)-3,3,5-trimethylcyclohexane. The bisphenol compounds to be used according to the invention are reacted with carbonic acid compounds, in particular phosgene or, in the melt transesterification process, diphenyl carbonate or dimethyl carbonate.

Polyester carbonates are obtained by reacting the bisphenols already mentioned, at least one aromatic dicarboxylic acid and optionally carbonic acid equivalents. Suitable aromatic dicarboxylic acids are, for example, phthalic acid, terephthalic acid, isophthalic acid, 3,3′- or 4,4′-diphenyldicarboxylic acid and benzophenonedicarboxylic acids. A portion, up to 80 mol %, preferably from 20 to 50 mol %, of the carbonate groups in the polycarbonates can be replaced by aromatic dicarboxylic acid ester groups.

Inert organic solvents used in the interfacial process are, for example, dichloromethane, the various dichloroethanes and chloropropane compounds, tetrachloromethane, trichloromethane, chlorobenzene and chlorotoluene. Chlorobenzene or dichloromethane and mixtures of dichloromethane and chlorobenzene are preferably used.

The interfacial reaction can be accelerated by catalysts such as tertiary amines, in particular N-alkylpiperidines or onium salts. Tributylamine, triethylamine and N-ethylpiperidine are preferably used. In the case of the melt transesterification process, the catalysts mentioned in DE-A 42 38 123 are used.

The polycarbonates can be branched in a deliberate and controlled manner by the use of small amounts of branching agents. Some suitable branching agents are: isatin biscresol, phloroglucinol, 4,6-dimethyl-2,4,6-tri-(4-hydroxyphenyl)-hept-2-ene; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxy-phenyl)-phenylmethane; 2,2-bis-[4,4-bis-(4-hydroxyphenyl)-cyclohexyl]-propane; 2,4-bis-(4-hydroxyphenyl-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl)-orthoterephthalic acid ester; tetra-(4-hydroxyphenyl)-methane; tetra-(4-(4-hydroxyphenyl-iso-propyl)-phenoxy)-methane; α,α′,α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)-benzene and in particular: 1,1,1 -tri-(4-hydroxyphenyl)-ethane and bis-(3-methyl-4-hydroxyphenyl)-2-oxo-2,3-dihydroindole.

The branching agents or mixtures of branching agents which are optionally to be used concomitantly in an amount of from 0.05 to 2 mol %, based on diphenols used, can be used together with the diphenols or can also be added to the synthesis at a later stage.

Chain terminators can be used. There are preferably used as chain terminators phenols such as phenol, alkylphenols such as cresol and 4-tert-butylphenol, chlorophenol, bromophenol, cumylphenol or mixtures thereof, in amounts of from 1 to 20 mol %, preferably from 2 to 10 mol %, per mol of bisphenol. Phenol, 4-tert-butylphenol and cumylphenol are preferred.

Chain terminators can be added to the syntheses separately or together with the bisphenol.

The polycarbonate that is particularly preferred according to the invention is bisphenol A homopolycarbonate.

Alternatively, the polycarbonates according to the invention can also be prepared by the melt transesterification process. The melt transesterification process is described, for example, in Encyclopedia of Polymer Science, Vol. 10 (1969), Chemistry and Physics of Polycarbonates, Polymer Reviews, H. Schnell, Vol. 9, John Wiley and Sons, Inc. (1964) and in DE-C 10 31 512.

In the melt transesterification process, the aromatic dihydroxy compounds already described in connection with the interfacial process are transesterified in the melt with carbonic acid diesters with the aid of suitable catalysts and optionally further additives.

Carbonic acid diesters within the scope of the invention are those of formulae (1) and (2)

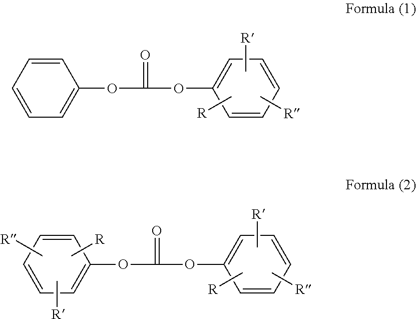

wherein
R, R′ and R″ independently of one another can represent H, optionally branched C₁-C₃₄-alkyl/cycloalkyl, C₇-C₃₄-alkaryl or C₆-C₃₄-aryl,

for example

diphenyl carbonate, butylphenyl-phenyl carbonate, di-butylphenyl carbonate, isobutylphenyl-phenyl carbonate, di-isobutylphenyl carbonate, tert-butylphenyl-phenyl carbonate, di-tert-butylphenyl carbonate, n-pentylphenyl-phenyl carbonate, di-(n-pentylphenyl) carbonate, n-hexylphenyl-phenyl carbonate, di-(n-hexylphenyl) carbonate, cyclohexylphenyl-phenyl carbonate, di-cyclohexylphenyl carbonate, phenylphenol-phenyl carbonate, di-phenylphenol carbonate, isooctylphenyl-phenyl carbonate, di-isooctylphenyl carbonate, n-nonylphenyl-phenyl carbonate, di-(n-nonylphenyl) carbonate, cumylphenyl-phenyl carbonate, di-cumylphenyl carbonate, naphthylphenyl-phenyl carbonate, di-naphthylphenyl carbonate, di-tert-butylphenyl-phenyl carbonate, di-(di-tert-butylphenyl) carbonate, dicumylphenyl-phenyl carbonate, di-(dicumylphenyl) carbonate, 4-phenoxyphenyl-phenyl carbonate, di-(4-phenoxyphenyl) carbonate, 3-pentadecylphenyl-phenyl carbonate, di-(3-pentadecylphenyl) carbonate, tritylphenyl-phenyl carbonate, di-tritylphenyl carbonate,

preferably

diphenyl carbonate, tert-butylphenyl-phenyl carbonate, di-tert-butylphenyl carbonate, phenylphenol-phenyl carbonate, di-phenylphenol carbonate, cumylphenyl-phenyl carbonate, di-cumylphenyl carbonate, particularly preferably diphenyl carbonate.

Mixtures of the mentioned carbonic acid diesters can also be used.

The proportion of carbonic acid ester is from 100 to 130 mol %, preferably from 103 to 120 mol %, particularly preferably from 103 to 109 mol %, based on the dihydroxy compound.

Within the scope of the invention there are used as catalysts in the melt transesterification process, as described in the mentioned literature, basic catalysts such as, for example, alkali and alkaline earth hydroxides and oxides, but also ammonium or phosphonium salts, referred to hereinbelow as onium salts. Preference is given to the use of onium salts, particularly preferably phosphonium salts. Phosphonium salts within the meaning of the invention are those of formula (3)

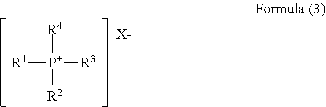

wherein
R¹⁻⁴ can be the same or different C₁-C₁₀-alkyls, C₆-C₁₀-aryls, C₇-C₁₀-aralkyls or C₅-C₆-cycloalkyls, preferably methyl, or C₆-C₁₄-aryls, particularly preferably methyl or phenyl, and
X— can be an anion such as hydroxide, sulfate, hydrogen sulfate, hydrogen carbonate, carbonate, a halide, preferably chloride, or an alcoholate of formula OR, wherein R can be C₆-C₁₄-aryl or C₇-C₁₂-aralkyl, preferably phenyl.

Preferred catalysts are
tetraphenylphosphonium chloride,
tetraphenylphosphonium hydroxide,
tetraphenylphosphonium phenolate,
tetraphenylphosphonium phenolate is particularly preferred.

The catalysts are preferably used in amounts of from 10⁻⁸ to 10⁻³ mol, based on one mol of bisphenol, particularly preferably in amounts of from 10⁻⁷ to 10⁻⁴ mol.

Further catalysts can be used alone or optionally in addition to the onium salt in order to increase the rate of polymerisation. These include salts of alkali metals and alkaline earth metals, such as hydroxides, alkoxides and aryl oxides of lithium, sodium and potassium, preferably hydroxide, alkoxide or aryl oxide salts of sodium. Sodium hydroxide and sodium phenolate are most preferred. The amounts of cocatalyst can be in the range from 1 to 200 ppb, preferably from 5 to 150 ppb and most preferably from 10 to 125 ppb, in each case calculated as sodium.

The transesterification reaction of the aromatic dihydroxy compound and the carbonic acid diester in the melt is preferably carried out in two stages. In the first stage, melting of the aromatic dihydroxy compound and of the carbonic acid diester takes place in from 0 to 5 hours, preferably from 0.25 to 3 hours, at temperatures of from 80 to 250° C., preferably from 100 to 230° C., particularly preferably from 120 to 190° C., under normal pressure. After addition of the catalyst, the oligocarbonate is prepared from the aromatic dihydroxy compound and the carbonic acid diester by distilling off the monophenol by application of a vacuum (up to 2 mm Hg) and increasing the temperature (to up to 260° C.). The majority of the vapours from the process are obtained thereby. The oligocarbonate so prepared has a mean weight-average molar mass M_{w} (determined by measuring the relative solution viscosity in dichloromethane or in mixtures of equal amounts by weight of phenol/o-dichlorobenzene calibrated by light scattering) in the range from 2000 g/mol to 18,000 g/mol, preferably from 4000 g/mol to 15,000 g/mol.

In the second stage, the polycarbonate is prepared in the polycondensation by further increasing the temperature to from 250 to 320° C., preferably from 270 to 295° C., and a pressure of <2 mm Hg. The remaining vapours are thereby removed from the process.

The catalysts can also be used in combination (two or more) with one another.

When alkali/alkaline earth metal catalysts are used, it can be advantageous to add the alkali/alkaline earth metal catalysts at a later time (e.g. after the oligocarbonate synthesis during the polycondensation in the second stage).

Within the scope of the process according to the invention, the reaction of the aromatic dihydroxy compound and the carbonic acid diester to give the polycarbonate can be carried out discontinuously or, preferably, continuously, for example in stirrer vessels, thin-layer evaporators, falling film evaporators, stirrer vessel cascades, extruders, kneaders, simple plate reactors and high-viscosity plate reactors.

Analogously to the interfacial process, branched poly- or copoly-carbonates can be prepared by the use of polyfunctional compounds.

It is possible to add to the polycarbonates and copolycarbonates according to the invention in known manner, for example by compounding, further plastics materials such as polyamides, polyimides, polyester amides, polyacrylates and polymethacrylates such as, for example, polyalkyl (meth)acrylates and in particular polymethyl methacrylate, polyacetals, polyurethanes, polyolefins, halogen-containing polymers, polysulfones, polyether sulfones, polyether ketones, polysiloxanes, polybenzimidazoles, urea-formaldehyde resins, melamine-formaldehyde resins, phenol-formaldehyde resins, alkyd resins, epoxy resins, polystyrenes, copolymers of styrene or alpha-methylstyrene with dienes or acryl derivatives, graft polymers based on acrylonitrile/butadiene/styrene or graft polymers based on acrylate rubber (see, for example, the graft polymers described in EP-A 640 655), or silicone rubbers.

It is further possible to add aromatic polyesters or aromatic/aliphatic, thermoplastic polyesters whose acid component consists of at least 85 mol % terephthalic acid and whose diol component consists of at least 80 mol % 1,4-butanediol, 1,2-ethanediol and/or 1,4-cyclohexanedimethanol. These are, for example, polyesters with butylene terephthalate, ethylene terephthalate and/or cyclohexanedimethanol terephthalate units.

The diol component of these polyesters can consist of up to 20 mol % other aliphatic diols having from 3 to 12 carbon atoms or cycloaliphatic diols having from 6 to 21 carbon atoms. Examples which may be mentioned here are 1,3-propanediol, neopentyl glycol, 1,5-pentanediol, 1,6-hexanediol, 3-methyl-2,4-pentanediol, 2-methyl-2,4-pentanediol, 2,2,4-trimethyl-1,3-pentanediol. In addition to terephthalic acid, up to 15 mol % dicarboxylic acids, for example isophthalic acid, adipic acid, succinic acid, sebacic acid, naphthalene-2,6-dicarboxylic acid, diphenyldicarboxylic acid, azelaic acid, cyclohexanediacetic acid, can be present in the acid component.

Preference is given to the use of polybutylene terephthalates, for example Pocan® 1300, an aromatic polyester obtainable from Lanxess AG.

For the acrylate-based scattering additives present in the composition according to the invention there are preferably used polymethyl methacrylate-containing additives, for example polymeric particles of polymethyl methacrylate and polybutyl acrylate with core-shell morphology, for example obtainable as Paraloid® EXL 5136 or Paraloid® EXL 5137 from Rohm&Haas, or partially or fully crosslinked spherical or non-spherical acrylate particles, such as, for example, those from the Techpolymer® MBX series from Sekisui Plastics.

Scattering additives with core-shell morphology are described, for example, in EP 0 634 445 B1 as “polymeric particle (b)”.

The scattering additives generally have an average particle diameter of at least 0.5 micrometre, preferably at least 2 micrometres, more preferably from 2 to 50 micrometres, most preferably from 2 to 15 micrometres. The average is here to be understood as being the number average of the particle diameters and the particle diameter is to be understood as being the diameter of a sphere having a volume equivalent to the particle. Preferably at least 90% have a diameter of more than 2 micrometres. The scattering additives are used, for example, in the form of free-flowing powder or in compacted form.

The brominated flame retardants which are further used in the composition according to the invention are preferably brominated oligocarbonates, in particular tetrabromobisphenol A oligomers, for example tetrabromobisphenol A oligocarbonate BC-52®, BC-58®, BC-52HP® from Chemtura. Preference is further given also to polypentabromobenzyl acrylates (e.g. FR 1025® from Dead Sea Bromine (DSB)), oligomeric reaction products of tetrabromobisphenol A with epoxides (e.g. FR 2300® and 2400® from DSB), or brominated oligo- or poly-styrenes (e.g. Pyro-Chek® 68PB from Ferro Corporation, PDBS 80® and Firemaster® PBS-64HW from Chemtura). The tetrabromobisphenol A oligomers are particularly preferred.

The phosphorus-based flame retardants contained in the composition according to the invention preferably consist of oligomeric phosphoric acid esters which are derived from the following formula (4):

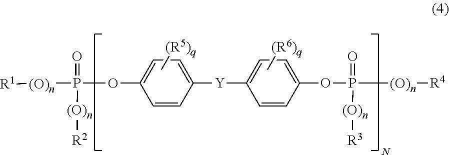

wherein
R¹, R², R³ and R⁴ independently of one another denote C₁-C₈-alkyl optionally substituted by halogen, C₅-C₆-cycloalkyl, C₆-C₁₀-aryl or C₇-C₁₂-aralkyl each optionally substituted by halogen and/or by alkyl,
the substituents n independently of one another denote 0 or 1,
the substituents q independently of one another denote 0, 1, 2, 3 or 4,
and
N is from 0.50 to 4.00, preferably from 0.90 to 2.50, in particular from 1.00 to 1.15,
R⁵ and R⁶ independently of one another denote C₁-C₄-alkyl, preferably methyl, or halogen, preferably chlorine and/or bromine,
Y denotes C₁-C₇-alkylidene, C₁-C₇-alkylene, C₅-C₁₂-cycloalkylene, C₅-C₁₂-cyclo-alkylidene, —O—, —S—, —SO—, —SO₂—, —CO— or a radical of formula (5) or (6)

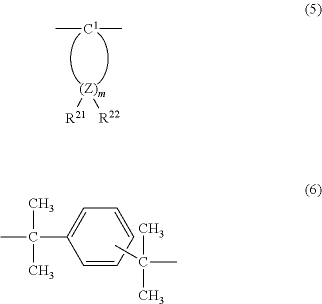

wherein
Z=carbon and
R²¹ and R²² can be selected individually for each Z and independently of one another are hydrogen or C1-C6-alkyl, preferably hydrogen, methyl or ethyl, and
m is an integer from 4 to 7, preferably 4 or 5,
with the proviso that on at least one atom Z R²¹ and R²² are simultaneously alkyl.

The phosphorus compounds according to formula (4) which are suitable according to the invention are generally known (see, for example, Ullmanns Encyklopädie der Technischen Chemie, Vol. 18, p. 301 ff 1979; Houben-Weyl, Methoden der Organischen Chemie, Vol. 12/1, p. 43; Beilstein, Vol. 6, p. 177).

Preferred substituents R¹ to R⁴ include methyl, butyl, octyl, chloroethyl, 2-chloropropyl, 2,3-dibromopropyl, phenyl, cresyl, cumyl, naphthyl, chlorophenyl, bromophenyl, pentachlorophenyl and pentabromophenyl. Methyl, ethyl, butyl, phenyl and naphthyl are particularly preferred.

The aromatic groups R¹, R², R³ and R⁴ can be substituted by halogen and/or C₁-C₄-alkyl. Particularly preferred aryl radicals are cresyl, phenyl, xylenyl, propylphenyl or butylphenyl as well as also the brominated and chlorinated derivatives thereof.

R⁵ and R⁶ independently of one another preferably denote methyl or bromine

Y preferably represents C₁-C₇-alkylene, in particular isopropylidene or methylene, most particularly preferably isopropylidene.

The substituents n in formula (4) independently of one another can be 0 or 1, preferably n is 1.

q can be 0, 1, 2, 3 or 4, preferably q is 0, 1 or 2.

N can assume values of from 0.50 to 4.00, preferably from 0.90 to 2.50, in particular from 1.00 to 1.15. Mixtures of different phosphates can also be used as the flame retardant of formula (4) according to the invention. In that case, N is an average value. Monophosphorus compounds (N=0) can also be present in that mixture.

Preferably, the proportion of monophosphorus compounds (N=0) in the flame retardant according to formula (4) is less than or equal to 5.00 wt. %, preferably less than or equal to 4.00 wt. %, particularly preferably less than or equal to 3.00 wt. %.

The mean N values can be determined by determining the composition of the phosphate mixture by a suitable method (gas chromatography (GC), high pressure liquid chromatography (HPLC), gel permeation chromatography (GPC)) and calculating the mean values for N therefrom.

Within the context of the present invention, the phosphorus compounds of formula (4) are used in amounts of from 0.50 wt. % to 7.00 wt. %, preferably from 1.00 wt. % to 6.00 wt. %, particularly preferably from 2.50 wt. % to 5.50 wt. %.

The mentioned phosphorus compounds are known (see e.g. EP-A 363 608, EP-A 640 655) or can be prepared by known methods in an analogous manner (e.g. Ullmanns Enzyklopädie der technischen Chemie, Vol. 18, p. 301 ff 1979; Houben-Weyl, Methoden der organischen Chemie, Vol. 12/1, p. 43; Beilstein Vol. 6, p. 177).

Particular preference is given within the context of the present invention to bisphenol A diphosphate. Bisphenol A diphosphate is commercially available inter alia as Reofos® BAPP (Chemtura, Indianapolis, USA), NcendX® P-30 (Albemarle, Baton Rouge, La., USA), Fyrolflex® BDP (Akzo Nobel, Arnheim, Netherlands) or CR 741® (Daihachi, Osaka, Japan).

Further phosphoric acid esters which can be used within the context of the present invention are additionally triphenyl phosphate, which is supplied inter alia as Reofos® TPP (Chemtura), Fyrolflex® TPP (Akzo Nobel) or Disflamoll® TP (Lanxess), as well as resorcinol diphosphate. Resorcinol diphosphate can be obtained commercially as Reofos RDP (Chemtura) or Fyrolflex® RDP (Akzo Nobel).

There can be added to the polycarbonates according to the invention and the further plastics materials that are optionally present also the additives conventional for such thermoplastics, such as fillers, UV stabilisers, heat stabilisers, antistatics and pigments, in the conventional amounts; the demoulding behaviour and the flow behaviour can optionally be further improved by the addition of external demoulding agents and flow agents (e.g. low molecular weight carboxylic acid esters, chalk, quartz flour, glass and carbon fibres, pigments and combinations thereof). Additives conventionally used for polycarbonate are described, for example, in WO 99/55772, p. 15-25, EP 1 308 084 and in the appropriate chapters of “Plastics Additives Handbook”, ed. Hans Zweifel, 5th Edition 2000, Hanser Publishers, Munich.

The salts optionally added to further increase the flame resistance of the composition according to the invention are, for example, alkali and alkaline earth salts of aliphatic and aromatic sulfonic acid, sulfonamide and sulfonimide derivatives, for example sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium methylphosphonate, sodium or potassium (2-phenyl-ethylene)-phosphonate, sodium or potassium pentachlorobenzoate, sodium or potassium 2,4,6-trichlorobenzoate, sodium or potassium 2,4-dichlorobenzoate, lithium phenylphosphonate, sodium or potassium diphenylsulfone-sulfonate, sodium or potassium 2-formylbenzenesulfonate, sodium or potassium (N-benzenesulfonyl)-benzenesulfonamide, trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium lithiumphosphate, N-(p-tolylsulfonyl)-p-toluenesulfimide potassium salt, N-(N′-benzylaminocarbonyl)-sulfanylimide potassium salt.

Preference is given to sodium or potassium perfluorobutanesulfate, sodium or potassium perfluorooctanesulfate, sodium or potassium diphenylsulfone-sulfonate and sodium or potassium 2,4,6-trichlorobenzoate and N-(p-tolylsulfonyl-)-p-toluenesulfimide potassium salt, N-(N′-benzylaminocarbonyl)-sulfanylimide potassium salt. Potassium nona-fluoro-1-butanesulfonate and sodium or potassium diphenylsulfonesulfonate are most particularly preferred. Potassium perfluorobutanesulfonate is available commercially inter alia as Bayowet®C4 (Lanxess, Leverkusen, Germany), RM64 (Miteni, Italy) or as 3M™ Perfluorobutanesulfonyl Fluoride FC-51 (3M, USA). Mixtures of the mentioned salts are likewise suitable.

Polytetrafluoroethylene (PTFE) can additionally be added to the moulding compositions as antidripping agent. PTFE is available commercially in various product grades. These include additives such as Hostaflon® TF2021 or PTFE blends such as Metablen® A-3800.

Furthermore, chlorine-containing flame retardants such as, for example, tetrachlorophthalimides can additionally be used.

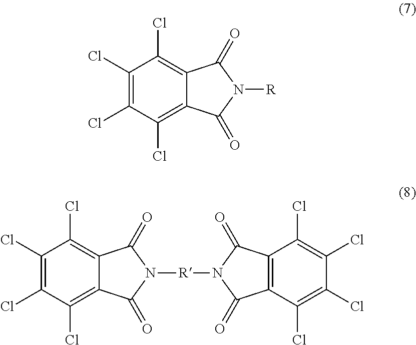

Examples of suitable tetrachlorophthalimides within the scope of the invention according to formula (7) which may be mentioned are: N-methyl tetrachlorophthalimide, N-ethyl tetrachlorophthalimide, N-propyl tetrachlorophthalimide, N-isopropyl tetrachlorophthalimide, N-butyl tetrachlorophthalimide, N-isobutyl tetrachlorophthalimide, N-phenyl tetrachlorophthalimide, N-(4-chlorophenyl)tetrachlorophthalimide, N-(3,5-dichlorophenyl)tetrachlorophthalimide, N-(2,4,6-trichlorophenyl)tetrachlorophthalimide, N-naphthyl tetrachlorophthalimide. Examples of suitable tetrachlorophthalimides within the scope of the invention according to formula (7) which may be mentioned are: N,N′-ethylene di-tetrachlorophthalimide, N,N′-propylene di-tetrachlorophthalimide, N,N′-butylene di-tetrachlorophthalimide, N,N′-p-phenylene di-tetrachlorophthalimide, 4,4′-di-tetrachlorophthalimido-diphenyl, N-(tetrachlorophthalimido)-tetrachlorophthalimide. Especially suitable according to the invention are N-methyl and N-phenyl tetrachlorophthalimide, N,N′-ethylene di-tetrachlorophthalimide and N-(tetrachlorophthalimido)-tetrachlorophthalimide. Mixtures of different tetrachlorophthalimides of formula (7) or (8) can likewise be used.

The bromine- or chlorine-containing flame retardants can also be used in combination with antimony trioxide.

The present invention is not limited to the mentioned flame retardants; in fact, further flame-inhibiting additives, as described, for example, in J. Troitzsch, “International Plastics Flammability Handbook”, Hanser Verlag, Munich 1990, can be used.

Within the context of the present invention, the compositions according to the invention particularly preferably contain a flame retardant combination of a phosphoric acid ester according to formula (4) and tetrabromobisphenol A oligocarbonate.

The preparation of a composition containing polycarbonate and the mentioned additional ingredients and additives can be carried out by conventional incorporation processes, for example by mixing solutions of the additional ingredients and a solution of the polycarbonate in suitable solvents such as dichloromethane, haloalkanes, haloaromatic compounds, chlorobenzene and xylenes. The mixtures are then preferably homogenised in known manner by extrusion. The solution mixtures are preferably worked up, for example compounded, in known manner by evaporation of the solvent and subsequent extrusion.

In addition, the composition can be mixed in conventional mixing devices such as screw extruders (for example twin-screw extruder, ZSK), kneaders, Brabender or Banbury mills, and then extruded. After the extrusion, the extrudate can be cooled and comminuted. It is also possible for individual components to be premixed and the remaining starting materials then to be added individually and/or likewise in the form of a mixture.

After the preparation and working up of the composition according to the invention, it can be processed to moulded articles of any kind, for example by extrusion, injection moulding or extrusion blow moulding. The compositions are preferably processed to (co)extruded moulded articles, such as, for example, sheets.

Linear and/or branched polycarbonate can be used as the base material for such sheets.

Linear polycarbonate is preferably used for solid sheets.

For multiwall sheets, linear and/or branched polycarbonate is used. Preference is given to the use of mixtures containing at least 50.00 wt. %, preferably at least 60.00 wt. %, particularly preferably at least 70 wt. %, linear polycarbonate and at least 10.00 wt. % branched polycarbonate.

The sheets preferably consist of at least 80 wt. % (branched and linear in total) bisphenol A polycarbonate.

The sheets within the scope of the invention preferably contain at least one cover layer containing UV absorber. The base layer can likewise contain UV absorber. Cover layers can be applied to one side or to both sides. The thickness of the coextruded cover layers is usually from 5 to 150 μm, preferably from 20 to 100 μm.

The thickness of the cover layer can vary slightly over the width. The polycarbonate of the cover layer can consist of linear and/or branched polycarbonate; linear polycarbonate is preferably used.

The cover layer preferably contains one or more UV absorbers selected from the group containing the following substances: triazines, benztriazoles, cyanoacrylates and bismalonates.

The cover layer most particularly preferably contains one or more UV absorbers selected from the following substances: 2-[2-hydroxy-4-(2-ethylhexyl)oxy]phenyl-4,6-di(4-phenyl)phenyl-1,3,5-triazine (CAS No. 204583-39-1); 2-(2H-benzotriazol-2-yl)-4-(1,1-dimethylethyl)-6-(1-methylpropyl)-phenol (CAS No. 36437-37-3), which is available commercially under the name Tinuvin® 350 from Ciba; 2,2′-methylenebis [6-(2H-benzotriazol-2-yl)-4-(1,1,3,3-tetramethylbutyl)-phenol (CAS No. 103597-45-1), which is available commercially under the name Tinuvin® 360 from Ciba or under the name ADK Stab LA31® from Adeka-Palmarole; 2-(4,6-diphenyl-1,3,5-triazin-2-yl)-5-(hexyloxy)-phenol (CAS No. 147315-50-2), which is available commercially under the name Tinuvin® 1577 from Ciba; 2-[4,6-bis(2,4-dimethylphenyl)-1,3,5-triazin-2-yl]-5-(octyloxy)-phenol (CAS No. 2725-22-6), which is available commercially under the name Cyasorb® UV-1164 from Cytec Industries Inc.; ethyl 2-cyano-3,3-diphenylacrylate (CAS No. 5232-99-5), which is available commercially under the name Uvinul® 3035 from BASF AG; 2-ethylhexyl 2-cyano-3,3-diphenylacrylate (CAS No. 6197-30-4), which is available commercially under the name Uvinul® 3039 from BASF AG; 1,3-bis-[(2′-cyano-3′,3′-diphenylacryloyl)oxy]-2,2-bis-{[(2′-cyano-3′,3′-diphenylacryloyl)oxy]-methyl}-propane (CAS No. 178671-58-4), which is available commercially under the name Uvinul® 3030 from BASF AG; tetra-ethyl 2,2′-(1,4-phenylene-dimethylidene)-bismalonate (CAS No. 6337-43-5), which is available commercially under the name Hostavin® B-CAP™ XP3030 from Clariant GmbH.

The base layer of the sheets according to the invention contains either no UV absorber or one or more UV absorbers selected from the following substance classes: benztriazoles, cyanoacrylates, bismalonates.

Preferably, the base layer of the sheets according to the invention contains one or more UV absorbers, particularly preferably selected from the following substances: 2-(2H-benzotriazol-2-yl)-4-(1,1,3,3-tetramethylbutyl)-phenol (CAS No. 3147-75-9), which is available commercially under the name Tinuvin® 329 from Ciba or under the name Uvinul® 3029 from BASF AG or under the name Cyasorb® UV-5411 from Cytec Industries Inc.; 2-(2H-benzotriazol-2-yl)-4,6-bis(1-methyl-1-phenylethyl)-phenol (CAS No. 70321-86-7), which is available commercially under the name Tinuvin 234® from Ciba; 2-(5-chloro-2H-benzotriazol-2-yl)-6-(1,1-dimethylethyl)-4-methyl)-phenol (CAS No. 3896-11-5), which is available commercially under the name Tinuvin® 326 from Ciba or under the name Uvinul®3026 from BASF AG; 2,2′-methylenebis[6-(2H-benzotriazol-2-yl)-4-(1,1,3,3-tetramethylbutyl)-phenol (CAS No. 103597-45-1), which is available commercially under the name Tinuvin® 360 from Ciba or under the name ADK Stab LA31® from Adeka-Palmarole; ethyl 2-cyano-3,3-diphenylacrylate (CAS No. 5232-99-5), which is available commercially under the name Uvinul® 3035 from BASF AG; 2-ethylhexyl 2-cyano-3,3-diphenylacrylate (CAS No. 6197-30-4), which is available commercially under the name Uvinul® 3039 from BASF AG; 1,3-bis-[(2′-cyano-3′,3′-diphenylacryloyl)oxy]-2,2-bis-{[(2′-cyano-3′,3′-diphenylacryloyl)oxy]methyl}-propane (CAS No. 178671-58-4), which is available commercially under the name Uvinul® 3030 from BASF AG; tetra-ethyl 2,2′-(1,4-phenylene-dimethylidene)-bismalonate (CAS No. 6337-43-5), which is available commercially under the name Hostavin® B-CAP™ XP3030 from Clariant GmbH.

The amount by weight of the UV absorber in the cover layer is from 0.50 wt. % to 11.00 wt. %, preferably from 1.00 wt. % to 3.00 wt. % and in a particular embodiment from 4.00 wt. % to 8.00 wt. %, based on the total composition of the cover layer. The polycarbonate can be linear and/or branched, it can also contain mixtures of the above-mentioned UV absorbers, in which case the UV absorber weight data are based on the sum of the UV absorbers used. Where a UV absorber is used in the base layer, the amount by weight is from 0.01 wt. % to 1.00 wt. %, preferably from 0.10 wt. % to 0.50 wt. %, based on the total composition of the base layer.

The products according to the invention, in particular solid sheets or multiwall sheets, can also contain further functional or decorative layers, for example produced by coextrusion or coating processes. Applications of the products are found in the fields of architectural glazing, in particular roofing and glazing for swimming pools, carports, greenhouses, industrial complexes and private buildings, as well as soundproofing walls and screening walls.

### EXAMPLES

Raw Materials and Additives Used

Makrolon® DP1-1883 (new name since 2010: Makrolon® ET 3117) is available commercially from Bayer MaterialScience AG. It is a linear polycarbonate based on bisphenol A having a melt volume flow rate (MVR) determined according to ISO 1133 of 6.0 cm³/(10 min) at 300° C. and 1.2 kg load.

Makrolon 1243 MAS 157 (new name since 2010: Makrolon® ET 3127) is commercially available from Bayer MaterialScience AG. Makrolon® 1243 MAS 157 is a branched polycarbonate based on bisphenol A having a melt volume flow rate (MVR) according to ISO 1133 of 6.0 cm³/(10 min) at 300° C. and 1.2 kg load.

“Scattering additive compound”: This compound is a polycarbonate masterbatch based on linear polycarbonate based on bisphenol A as diphenol (having a melt volume flow rate (MVR) determined according to ISO 1133 of 6.0 cm³/(10 min) at 300° C. and 1.2 kg load) containing a scattering additive of core-shell particles based on polymethyl methacrylate and polybutyl acrylate with a particle size of from 2 to 15 μm and a mean particle size of 8 μm (Paraloid® EXL 5137 from Rohm & Haas) in an amount of about 20 wt. % (scattering additive).

Makrolon® DP1-1816 MAS 073 (new name since 2009: Makrolon® ET UV 510) is a linear polycarbonate based on bisphenol A containing UV absorber from Bayer MaterialScience AG having a melt volume flow rate (MVR) according to ISO 1133 of 8.5 cm³/(10 min) at 300° C. and 1.2 kg load.

Reofos® BAPP is a bisphenol A diphosphate (BDP) obtainable from Chemtura (Indianapolis, USA) of the formula

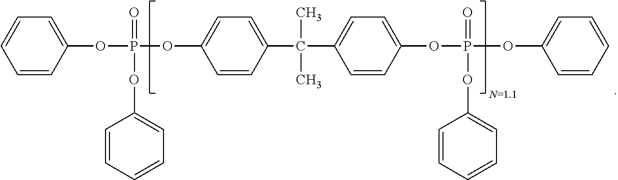

BC-52® is a tetrabromobisphenol A oligocarbonate (TBBOC) and is obtainable from Chemtura (Indianapolis, USA).

Preparation of the Polycarbonate Compositions for the Base Layers in the Examples Mentioned Below:

The polycarbonate compositions were prepared by compounding. The device for compounding consists of:
metering device for the components
a co-rotating twin-shaft kneader (ZSK 53 from Werner & Pfleiderer) having a screw diameter of 53 mm
a perforated die for forming melt strands
a water bath for cooling and consolidating the strands
a granulator.

In the preparation of the compounds, the procedure was such that there were added to the amounts of Makrolon® DP1-1883 indicated below a mixture of Makrolon® 1243 MAS 157 and the further additional ingredients indicated below, so that the mixtures (compounds) mentioned in the examples are obtained.

### Material for the Base Layer of Example 1 (Milky-White/Translucent)

77.5% Makrolon® DP1-1883

1.5% Makrolon® 1243 MAS 157

5% scattering additive compound

### Material for the Base Layer of Example 2 (Milky-White/Translucent)

75.5% Makrolon® DP1-1883

15.5% Makrolon® 1243 MAS 157

5% scattering additive compound

4% BC-52®

### Material for the Base Layer of Example 3 (Milky-White/Translucent)

75% Makrolon® DP1-1883

15% Makrolon® 1243 MAS 157

5% scattering additive compound

5% Reofos® BAPP

### Material for the Base Layer of Example 4 According to the Invention (Milky-White/Translucent)

73% Makrolon® DP1-1883

13% Makrolon® 1243 MAS 157

5% scattering additive compound

5% Reofos® BAPP

4% BC-52®

### Material for the Base Layer of Example 5 (Transparent)

80% Makrolon® DP1-1883

20% Makrolon® 1243 MAS 157

### Material for the Base Layer of Example 6 (Transparent)

78% Makrolon® DP1-1883

18% Makrolon® 1243 MAS 157

4% BC-52®

### Material for the Base Layer of Example 7 (Transparent)

77.5% Makrolon® DP1-1883

17.5% Makrolon® 1243 MAS 157

5% Reofos® BAPP

### Example 8 (Milky-White/Translucent)

73% Makrolon® DP1-1883

13% Makrolon® 1243 MAS 157

5% scattering additive compound

9% Reofos® BAPP

The compositions of Examples 1 to 7 were each used as the material for the base layer for the extrusion of the multiwall sheets. The case temperatures of the above-mentioned compounding extruder used for the production of the base materials were 60-80° C. in zone 1, 140-160° C. in zone 2, and between 280 and 305° C. in each of the following zones. The throughput was about 75 kg/h. The melt temperature was between 340° C. and 350° C. Reofos® BAPP was metered in molten form.

No multiwall sheets were produced from the composition of Example 8 because the dimensional stability of the sheet under heat, determined by the VICAT temperature of the composition, had an unacceptably low value. The Vicat softening temperature was determined according to DIN ISO 306 on test specimens (flat rod) measuring 80 ×10 ×4 mm. The Vicat B was determined under a load of 50 N at a heating rate of 120 K/h.

The table below shows the Vicat B of the material from Example 8 in comparison with Example 4 according to the invention.

TABLE 1

| Example No. | Vicat B [° C.] |
|---|---|
| 4 | 130 |
| 8 | 115 |

Production of the Five-Wall Polycarbonate Sheets

Five-wall polycarbonate sheets were produced by means of the following machines and apparatus:
a single-screw extruder (degassing extruder, screw diameter 70 mm and a single screw of length 33 D, single screw, Reifenhäuser, Troisdorf/Germany)
The extruder is equipped with vacuum melt degassing.
a 2-layer coextrusion adapter (fixed adapter from Bexsol, Italy)
a 3-zone coextruder (screw diameter 30 mm, single screw of length 25 D, Omipa, Italy)
a multiwall sheet die of width 500 mm for multiwall sheet thicknesses of from 8 to 45 mm from Bexsol, Italy
a two-part vacuum calibrator, width 500 mm, length 2 ×950 mm, Breyer, Singen/Germany
a roller conveyor, roller conveyor length (distance calibrator/cutting to length) 3.5 m
a take-off device
a transverse cutting device (knife)
a delivery table.

The cover layer (on one side) used in all Examples 1 to 7 was a material containing linear polycarbonate and a triazine-based UV absorber. This material is obtainable under the trade name Makrolon® DP1-1816 MAS 073 from Bayer MaterialScience AG. The cover layer is obtained by coextrusion.

The multiwall sheets provided on one side with a coextruded layer (Examples 1 7) were produced as follows: The polycarbonate granules of the base material were in each case fed to the feed hopper of the main extruder and melted and conveyed via the cylinder/screw. The temperatures of the individual cases of the main extruder were from 240° to 260° C., the resulting melt temperature was 240 to 255° C. The shaft speed was between 50 and 56 rpm. The Makrolon® DP1-1816 MAS 073 used as the material for the one-sided coextruded layer was fed to the filling hopper of the coextruder. The case temperatures of the coextruder were 265° C., the melt temperature was about 252° C. The shaft speed was 10 rpm.

The two material melts were combined in the coex adapter and then formed in a special extrusion die which is a multiwall sheet die for the production of a hollow section consisting of an upper chord, a lower chord and three middle chords. The section additionally has ribs with an X-shaped profile. The take-off speed was 0.7 m/s. The further devices of the systems were used for transporting, cutting to length and depositing the sheets.

The sheets extruded by means of this die have a thickness of about 40 mm and a sheet width of 510 mm and have a weight per unit area of 4.4 kg/m². The cover layer (from the coextrusion) contains Makrolon® DP1-1816 MAS 073 in a thickness of 50 μm. Ideally, the resulting multiwall sheet has the profile described in FIG. 1.

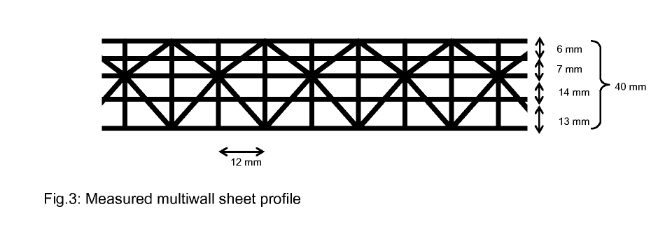

The multiwall sheets produced are five-wall sheets with deviations from the ideal geometry which are, however, not important for the fire behaviour. The sheet thickness and the weight per unit area especially are critical parameters for the fire behaviour. For the sake of completeness, the resulting multiwall sheet profile was measured again. The result is shown in FIG. 3. The coextruded layer is not shown in the figure, it is located on the upper chord in a thickness of 50 μm.

Flame Retardant Tests

The fire shaft test according to DIN 4102 specifies the following conditions: 4 samples measuring 19 cm×100 cm×original thickness are arranged vertically and at right angles to one another.

After flame impingement for 10 minutes with a ring burner, the burner is switched off. The fire shaft test is considered to be passed when—with a mean of the undamaged residual lengths of at least 150 mm and no completely burnt sample (residual length 0 mm)—the mean flue gas temperature does not exceed 200° C.

Before the test, the mouldings are stored under normal climatic conditions until they achieve constant weight. All fire tests were carried out in the certified fire house of Currenta GmbH & Co. OHG, Leverkusen according to DIN 4102. As the flame retardant test, the above-described fire shaft test was carried out on the sheets based on Examples 1 to 7 (used as base material). The results are shown in the table below.

As a further flame retardant test, a dripping test according to NF P 92-505 was carried out. This test is part of the test programme according to French building materials regulations. This test programme is divided into the cabin test, the electric burner test and the dripping test. Depending on the material, different tests are relevant. With regard to the performance of the thermoplastic material, the dripping test above all is important. In the test, the sample is arranged horizontally on a grid 30 mm away from the radiator. During the test period of 10 minutes, the ignition and dripping behaviour is observed. If the sample ignites in the first 5 minutes of the test, the radiator is turned away until the flames are extinguished. For the following 5 minutes, the thermal load, regardless of ignition, is not interrupted. “Flaming dripping” is present if in at least 4 tests the cellulose wadding located 300 mm beneath the sample is ignited. Flaming dripping results in the classification “failed”.

TABLE 2

| | Fire shaft | | | |
|---|---|---|---|---|
| | | Max. average | Max. | Dripping |
| Multiwall | | flue gas | absorption | test |
| sheet from | DIN | temperature | integral | NF P |
| Example | 4102-B1 | [° C.] | [%*min] | 92-505 |
| 1 | failed | >300 | — | failed |
| 2 | failed | >300 | — | passed |
| 3 | passed | 120.7 | 82.3 | failed |
| 4 | passed | 117.9 | 102.3 | passed |
| 5 | passed | 136.3 | 100.7 | failed |
| 6 | passed | 127.8 | 52.03 | passed |
| 7 | passed | 126.6 | 25.39 | passed |

Sheets without scattering additive (Examples 5 to 7) pass the flame retardant test on addition of one of the flame retardant additives based on TBBOC or BDP alone. However, for milky-white/translucent sheets containing scattering additive, the combination of flame retardants according to the invention is necessary (Example 4) in order to pass the relevant flame retardant tests. The flame retardants according to the invention are not sufficient on their own in this case.

Very high contents of the individual flame retardants are not economically expedient in the case of bromine-containing BC-52 because of its high price. Moreover, it is known to the person skilled in the art that high bromine contents are undesirable inter alia in the processing of thermoplastics because they tend to emit corrosive and harmful bromine vapours on processing.

The use of high contents of phosphorus-containing flame retardants such as Reofos® BAPP leads to unacceptably low dimensional stability under heat, determined, for example, by the Vicat temperature (see Example 8), which no longer meet the demands made of the polycarbonate sheets.

1-14. (canceled)

15. A composition comprising an aromatic polycarbonate and
a) from 0.10 to 4.00 weight % of at least one acrylate-based scattering additive;
b) from 0.50 to 7.00 weight % of at least one brominated flame retardant; and
c) from 0.50 to 7.00 weight % of at least one phosphorus-based flame retardant.

16. The composition of claim 15, wherein the brominated flame retardant b) is a tetrabromobisphenol A oligomer.

17. The composition of claim 15, wherein the phosphorus-based flame retardant is one or more compounds of formula (4) 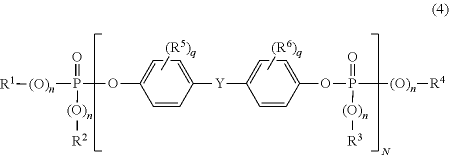
wherein
R¹, R², R³, and R⁴ are, independently of one another, C₁-C₈-alkyl optionally substituted by halogen, C₅-C₆-cycloalkyl, C₆-C₁₀-aryl, or C₇-C₁₂-aralkyl each optionally substituted by halogen and/or by aryl;
n is, independently of one another, 0 or 1;
q is, independently of one another, 0, 1, 2, 3, or 4;
N is from 0.60 to 4.00;
R⁵ and R⁶ are, independently of one another, C₁-C₄-alkyl, preferably methyl, or halogen; and
Y is C₁-C₇-alkylidene, C₁-C₇-alkylene, C₅-C₁₂-cycloalkylene, C₅-C₁₂-cycloalkylidene, —O—, —S—, —SO—, —SO₂—, —CO—, or a radical of formula (5) or (6) 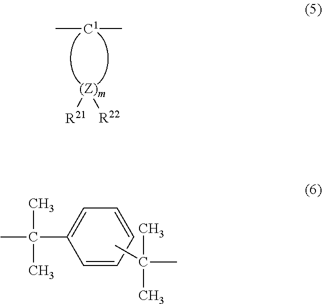
wherein
Z is carbon;
R²¹ and R²² can be selected individually for each Z and are, independently of one another, hydrogen or C₁-C₆-alkyl;
m is an integer from 4 to 7;
with the proviso that on at least one atom Z, R²¹ and R²² are simultaneously alkyl.

18. The composition of claim 17, wherein the phosphate-containing flame retardant is bisphenol A diphosphate.

19. The composition of claim 15, wherein the scattering additive is selected from the group consisting of core-shell polymers based on polymethyl acrylate and polybutyl acrylate, partially crosslinked spherical acrylate particles, fully crosslinked spherical acrylate particles, partially crosslinked non-spherical acrylate particles, and fully crosslinked non-spherical acrylate particles.

20. A sheet comprising the composition of claim 15.

21. The sheet of claim 20, wherein the sheet is a solid sheet or a multiwall sheet.

22. The sheet of claim 21, wherein it is a multilayer sheet comprising a base layer, wherein the composition is present in the base layer.

23. The sheet of claim 21, further comprising at least one coextruded cover layer comprising a UV absorber.

24. The sheet of claim 22, wherein the base layer comprises a mixture of branched and linear aromatic polycarbonates.

25. The sheet of claim 23, wherein the UV absorber is selected from the group consisting of triazines, benztriazoles, cyanoacrylates, bismalonates, and mixtures thereof, and the base layer does not contain a UV absorber or contains one more UV absorbers selected from the group consisting of benztriazoles, cyanoacrylates, and bismalonates.

26. The sheet of claim 20, wherein the sheet passes both the fire shaft test according to DIN 4102 B1 and the dripping test according to NF P 92-505.

27. Production of the sheet of claim 22 by coextrusion.

28. Use of the composition of claim 15 for avoiding flaming dripping and for reducing the maximum flue gas temperature in the event of fire as compared with compositions not finished according to the invention in extruded sheets.
